(19) United States
(12) Patent Application Publication
(10) Pub. No.: US 2026/0336626 A1
(43) Pub. Date: Oct. 29, 2026

(54) METHOD FOR CONTROLLING A SEMI-AUTOMATIC LANE CHANGE FUNCTION OF A MOTOR VEHICLE

(71) Applicant: AMPERE SAS, Boulogne Billancourt (FR)

(72) Inventor: Emmanuel LE-MEUR, Guyancourt cedex (FR)

(73) Assignee: AMPERE SAS, Boulogne Billancourt (FR)

(21) Appl. No.: 19/132,113

(22) PCT Filed: Nov. 14, 2023
(86) PCT No.: PCT/EP2023/081778

§ 371 Date: May 22, 2025

(30) Foreign Application Priority Data
Nov. 25, 2022 (FR) FR2212346

(51) Int. Cl. B60W 30/18

(52) U.S. Cl. CPC B60W 30/18163; B60W 2552/10; B60W 2555/80; B60W 2556/40; B60W 2556/45

(57) ABSTRACT

A method controls a motor vehicle when it is on a road with at least two traffic lanes and a semi-automatic lane change function is enabled. The method includes acquiring first data relating to the environment of the vehicle, comparing the first data acquired with a set of predetermined rules, determining whether the function is in an enabled or disabled state according to the result of the comparison, when the function is enabled and a lane change request is received from the driver, determining a control instruction for a control actuator of the vehicle, and applying the control instruction by the actuator to change traffic lane. The acquiring includes acquiring second data relating to the environment of the vehicle, which are separate from the first data compared with the rules, and then determining the state of the function and/or the control instruction according to the second data acquired.

### TECHNICAL FIELD OF THE INVENTION

The present invention relates in general to motor vehicle driving aids.

The invention relates more specifically to a method for controlling a motor vehicle, comprising, when the motor vehicle is on a road comprising at least two lanes and a semi-automatic lane change function of the motor vehicle is activated, the following steps:
acquiring first data relating to the environment of the motor vehicle,
comparing the acquired first data with a set of predetermined rules stemming from a national and/or international regulation,
determining an activated or deactivated state of said function depending on the result of said comparison, and then, if said function is activated,
when a lane change request is received from the driver of the motor vehicle, determining a control instruction for at least one actuator for controlling the motor vehicle, and
applying said control instruction by way of said at least one actuator so as to make the motor vehicle change lane.

The invention also relates to a motor vehicle suitable for implementing such a method. It applies more particularly to cars and other motorized machines traveling on roads.

### PRIOR ART

In order to make motor vehicles safer, said motor vehicles are nowadays equipped with driving assistance Systems or even with highly automated driving systems.

These are typically systems for keeping in the center of the lane (better known by the acronym LKA for lane keeping assist or LCA for lane centering assist) or semi-automated lane change systems (better known by the acronym SALC for semi-autonomous lane change).

The semi-automated lane change (SALC) function may be “activated” when the driver requests this, for example by pressing a button ad hoc or by selecting the function from a menu offered on a display screen. Once the function has been activated, the lane change may take place automatically as soon as the driver requests this (for example by actuating their indicators). The activation of the function thus does not lead directly to the lane change, this change being conditional on another action of the driver.

It is essential that the vehicle has a good understanding of its environment in order to implement this SALC function.

In this regard, a regulation provides criteria to monitor whether or not the lane change is able to be authorized, taking into account data relating to the environment. These environment data, once they have been acquired by sensors of the vehicle, make it possible more specifically to determine parameters (better known by the acronym ODD for operational design domain), which then make it possible to check, in binary fashion, whether or not the SALC function is able to be activated.

Typically, the regulation prohibits any lane change maneuver on roads comprising lanes for pedestrians or cyclists. In this configuration, this regulation stipulates that the SALC function must be deactivated.

Therefore, to benefit from this function again when the conditions allow, the driver has to reactivate it via the button or the menu available to them.

It is understood that this solution is inconvenient for the driver, who, as soon as they have passed through a zone deemed to be hazardous, will have to reactivate the function manually.

However, above all, one major drawback of this solution is that the decision to activate or deactivate the SALC function is very clear-cut. Indeed, this solution consists in complying with the rules stemming from the regulation in binary fashion. Thus, depending on the severity of the rules imposed, the SALC function may be activated in potentially hazardous zones, or on the contrary be deactivated in zones that are not particularly hazardous.

### PRESENTATION OF THE INVENTION

In order to rectify the abovementioned drawbacks of the prior art, the present invention proposes to refine the authorization to implement the SALC function depending on multiple criteria.

More particularly, what is proposed according to the invention is a control method as defined in the introduction, wherein provision is made, in the acquisition step, to acquire second data relating to the environment of the vehicle that are distinct from said first data (those compared to said rules), these second data then being used to:
determine the state of said SALC function, and/or to
correct said control instruction, when the SALC function is activated and a lane change is in progress, for example so as to reduce the time needed to be able to change the state of the function (in order to deactivate it or inhibit it).

The invention thus proposes to adopt an approach that is not binary but is based on multiple criteria in order to determine whether or not, taking into account the environment, the SALC function is able to be activated.

This solution makes it possible for example to make the profile of the maneuver slightly more aggressive in the event of dense traffic, in order to increase the success rate and the safety of the maneuver. During overtaking, it typically makes it possible to speed up the end of the maneuver if a significant change in situation is detected, or to return the vehicle to its initial location, for example if another vehicle ultimately risks interfering with the maneuver.

This solution preferably furthermore proposes not to totally deactivate the SALC function, but only to interrupt it temporarily (reference is made to inhibition), the function then reactivating automatically as soon as possible (thus meaning that the driver does not have to reactivate it manually).

It is thus possible to choose between three distinct states (activated, deactivated, inhibited), depending on whether the environment is considered to be safe, hazardous or potentially hazardous.

This solution thus makes it possible not to have to make a compromise since the SALC function may be made:
unavailable as soon as a hazard is potentially detected, even with a low probability,
available as soon as possible since it will reactivate automatically when it has only been inhibited, without waiting for the driver to attempt to reactivate it manually.

Other advantageous and non-limiting features of the control method according to the invention, taken individually or in any technically possible combination, are as follows:
in the determination step, the state of said function is chosen from among the following states: activated, deactivated and momentarily inhibited;
in the step of determining said state, provision is made to: choose either the deactivated state or one of the activated or momentarily inhibited states depending on the result of said comparison, and then, if the deactivated state has not been chosen, select the activated state or the momentarily inhibited state depending on the acquired second data;
when said function changes to the deactivated state, the acquisition and comparison steps are stopped, whereas, when said function changes to the momentarily inhibited state, the acquisition and comparison steps continue;
said control instruction may be corrected during a maneuver depending on the acquired second data;
in the acquisition step, at least some of the first and/or second data are acquired from a database of map data;
in the acquisition step, at least some of the first and/or second data are acquired via communication means with which the motor vehicle is equipped;
in the acquisition step, at least some of the first and/or second data are acquired via sensors with which the motor vehicle is equipped;
in the acquisition step, third data relating to the operating state and/or the position and/or the dynamics of the motor vehicle are acquired and, in the determination step, the state is selected depending on said third data.

The invention also proposes a motor vehicle comprising means for acquiring data relating to the environment of the vehicle, at least one actuator for controlling the motor vehicle, and a computer programmed to implement a control method as mentioned above.

Of course, the various features, variants and embodiments of the invention may be combined with one another in various combinations provided that they are not mutually exclusive or incompatible.

### DETAILED DESCRIPTION OF THE INVENTION

The following description with reference to the appended drawings, which are given by way of non-limiting examples, will give a good understanding of the content of the invention and how it may be implemented.

In the appended drawings:

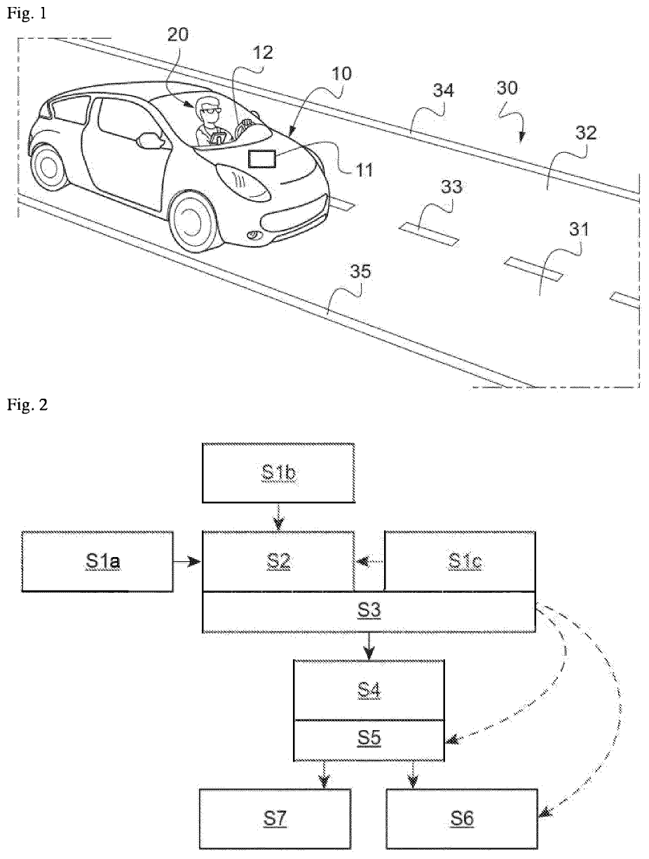

FIG. 1 is a schematic view of a motor vehicle suitable for implementing a method according to the present invention;

FIG. 2 is a block diagram illustrating various steps of a method according to the present invention.

FIG. 1 shows a motor vehicle 10 suitable for implementing the invention.

This is a car in this case. As a variant, it could be another type of vehicle (truck, motorcycle, etc.) .

In this case, this vehicle 10 comprises, as is conventional, a passenger compartment containing in particular a seat for the driver 20 of the vehicle and a steering wheel 12.

This vehicle 10 comprises a drivetrain, a braking system and a steering system for turning the vehicle (said conventional, the steering system comprises an electronically controllable power steering actuator, the drivetrain comprises an electronically controllable engine control actuator, and the braking system comprises an electronically controllable braking actuator.

The vehicle 10 also comprises an electronic and/or computerized processing unit (hereinafter called computer 11) comprising at least one microprocessor, at least one memory and input and output interfaces.

By virtue of its input interfaces, the computer 11 is able to receive various input data originating from Sensors or computers belonging to third parties.

These sensors include for example a device such as a front camera and a radar and/or lidar remote sensor, used to identify the edges of the lane in which the motor vehicle 10 is traveling and to characterize the environment of the motor vehicle 10.

By virtue of its output interfaces, the computer 11 is able to control the power steering actuator, the engine control actuator and the braking actuator.

By virtue of its input and output interfaces, the computer 11 is connected to a telecommunications chip allowing the computer 11 to communicate with third-party entities distinct from the motor vehicle 10. It is thus able for example to communicate with other vehicles or road infrastructures via a V2V (for vehicle-to-vehicle) or V2I (for vehicle-to-infrastructure) communication protocol. It may also use data from dynamic notification services or collaborative services (such as data available on the Waze navigation service).

The computer 11 may also communicate with a navigation system with which the vehicle is equipped, which comprises a geolocation chip and a storage unit storing a database of map data.

By virtue of its memory, the computer 11 stores a set of rules that stem from a national or international regulation and that, depending on the conditions, authorize or prohibit implementation of the SALC function. One example of such a regulation is clearly defined by the NHTSA (National Highway Traffic Safety Administration) in its program entitled Federal Automated Vehicles Policy, or by SAE International.

The computer 11 also stores a computer application consisting of computer programs comprising instructions that, when executed by the computer, allow the implementation of a function for automatically keeping the vehicle in the center of its lane (hereinafter called LCA function), of a semi-automatic lane change function (hereinafter called SALC function), and more generally of the method described below.

FIG. 1 shows the motor vehicle 10 in perspective when it is driving in a lane 31 of a road 30. It may be seen in FIG. 1 that the road 30 has two lateral marking lines 34, 35 (delimiting it) and a central marking line 33 delimiting the two lanes 31, 32.

A lane is defined here as being the portion of a road on which only a single vehicle at a time is permitted to travel. Such a lane is generally delimited between marking lines.

A road (or roadway) is for its part defined as being a set of lanes. In the example considered here by way of illustration, this road 30 therefore comprises two lanes 31 in which vehicles are able to travel in the same direction.

The objective of the present invention is to authorize the implementation of semi-automatic overtaking only when the conditions allow, but as soon as possible.

In practice, this method is implemented in a plurality of steps that are repeated in a loop at regular time intervals (of the order of a hundredth of a second).

These steps are illustrated in FIG. 2.

It will be assumed, for the clarity of the description, that the LCA and SALC functions are initially activated.

Since the LCA function is well known to those skilled in the art and is not itself the subject of the present invention, it will not be described in detail here.

It should be noted that the SALC function may be “activated” by the driver, by executing a task ad hoc consisting for example in pressing a button or in selecting the function from a menu displayed on a touchscreen located in the passenger compartment.

It should be noted that it may be “used” only if the SALC function is activated and if the driver issues the request to do so. To issue this request, the driver will have to for example set their indicator in the direction in which they wish to trigger the lane change.

The first step consists, for the computer 11, in acquiring a set of data relating to the environment of the motor vehicle.

This first step then comprises a sub-step S1a during which the computer records first preliminary data by way of the sensors (radar, camera, etc.) with which the motor vehicle 10 is equipped.

These first preliminary data may be used in raw form, or may possibly be processed again. Typically, the information originating from cameras and remote sensors may be compared, in an operation referred to as a fusion operation, in order to obtain more reliable data.

The first preliminary data make it possible for example to determine the following information: the number of lanes of the road 30, the width of the lanes, the position and type of upcoming intersections, the quality and nature of the lane marking lines, the nature of temporary lines signaling or not signaling roadworks, etc.

They also make it possible to determine the number of other vehicles nearby, their displacement vectors, and their natures (car, truck, emergency vehicle on a call, etc.).

They also make it possible to perceive road information such as static or dynamic signposts, roadworks cones, etc.

In other words, these first preliminary data make it possible to determine the position of the vehicle in its lane 31 and to characterize nearby objects (other vehicles, obstacles, etc.).

At this stage, the computer may also acquire data relating not to the environment of the vehicle but to the vehicle itself (position, dynamics, operating state of its sensors, etc.). In this case, the computer 11 acquires in particular the status of the indicators of the vehicle or the position of the actuator stalk for these indicators.

In a second sub-step S1b, the computer 11 acquires map-type second preliminary data. It acquires them from the navigation software, taking into account the position of the motor vehicle 10.

These data make it possible for example to characterize an intersection located ahead of the vehicle (typically an intersection not visible to the camera and the remote sensors), to determine a type of lane into which the vehicle is moving, etc.

In a third sub-step S1c, the computer 11 acquires third preliminary data, using its communication means.

These data allow for example a third-party entity (vehicle, infrastructure, etc.) to give the computer 11 its position and possibly its speed. They also make it possible, in advance, to detect a broken-down vehicle, a traffic jam, an emergency vehicle on a call.

It should be noted that the preliminary data acquired in sub-steps S1b and S1c make it possible to obtain in particular information from beyond the horizon “visible” to the equipment of the vehicle (camera, remote sensors, etc.).

In a second step S2, the computer collates the preliminary data so as to reconstruct an artificial horizon, that is to say to reconstruct the environment of the vehicle in digital form. This step does not necessarily consist in generating a 3D model of this environment. Rather, it consists in collating all of the preliminary data and in possibly processing them so as to establish a database characterizing the environment of the vehicle (typically the various objects located in this environment).

In a step S3, the computer 11 is thereby able to evaluate two types of data.

The first data ODD1 are those that will make it possible to check whether or not all of the rules defined above are satisfied (rules that, as it will be recalled, stem here from a national or international regulation).

The second data ODD2 are those that, in the context of the present invention, will make it possible to refine the authorizations to implement the SALC function.

Typically, a first datum ODD1 may correspond to the presence or absence of a cycle path on the road on which the motor vehicle 10 is traveling.

The set of first data ODD1 is clearly defined in the abovementioned regulation.

The second data ODD2 will not be subjected to these rules since they are not concerned thereby.

Typically, a second datum ODD2 may correspond to the presence or absence of an emergency vehicle on a call or to a roadworks zone in the proximity of the motor vehicle 10.

It will thus be possible, by virtue of the measurements carried out by the sensors with which the vehicle is equipped (step S1a) and/or by virtue of the artificial horizon (established by virtue of the data acquired in steps S1b & S1c), to detect zones that will potentially give rise to difficulties in which it will be necessary to temporarily inhibit or deactivate the SALC function, or to speed up the execution of the maneuver. These are for example roadworks zones, zones where an emergency vehicle is on call or arriving, zones where slippery roads are indicated, zones where pedestrians or cyclists are detected on the edge of the road, zones with dense traffic prompting the system to carry out a faster lane change (to the detriment of comfort but allowing higher confidence to carry out the maneuver).

On the other hand, it will also be possible to detect zones without any specific difficulty, which will also make it possible to increase confidence in the possibility of carrying out a lane change maneuver. These will be for example a zone in which a significant number of other vehicles use regular messages to transmit their positions distributed over two lanes, with relatively similar speeds over a distance allowing an overtaking maneuver using the SALC function.

The data thus make it possible to influence the execution of the maneuver. Indeed, increasing the level of confidence in the map information with perception elements of the vehicle (visualizing the number of lanes, the nature of the ground lines, or a central reservation) makes it possible to better qualify the environment.

These data also make it possible to influence the way in which the driver is informed that the maneuver is taking place.

During a step S4, provision is made to determine the trajectory that the motor vehicle should take when the LCA function alone is activated (typically the trajectory located in the middle of the separation lines 33, 35 of the lane 31 in which the motor vehicle 10 is traveling).

The computer 11 may also determine the trajectory that the motor vehicle could take in order to carry out a lane change.

Next, in a step S5, provision is made to compare the acquired first data ODD1 with the set of rules stemming from the abovementioned regulation.

Since these rules are well known, this step will not be described in more detail here. It may only be noted that they make it possible to determine the environment in which it will not be permitted to implement semi-automatic overtaking and in which the SALC function will more specifically have to be deactivated.

It will be understood that, when the conditions allow (for example when the road no longer comprises any cycle paths), the driver will be able to reactivate this function by carrying out the task required to do so (selecting the function on a menu, pressing a button, etc.).

By contrast, if all of the rules are satisfied, the state of the function may be chosen from two alternatives: an activated state or a momentarily inhibited state.

To make this choice, the computer 11 will compare the second data ODD2 with a set of rules stemming not from a national or international regulation, but stemming from execution principles determined by the manufacturer of the vehicle.

More precisely, the momentarily inhibited state will be selected as soon as one of these principles is not complied with.

Typically, if an intersection is detected at a distance close to the vehicle (taking into account its speed), the SALC function may be inhibited so as to prevent the driver from triggering semi-automatic overtaking in such a zone deemed to be hazardous.

In the same way, this function will be inhibited transiently in roadworks zones, when an emergency vehicle on a call is present, etc.

If all of the execution principles are complied with, on the other hand, the computer 11 keeps the SALC function in the activated state.

The main difference between the deactivated state and the momentarily inhibited state is that, in the deactivated state, the driver has to perform a specific task to relaunch the SALC function, whereas, in the momentarily inhibited state, the computer is able to automatically reactivate this function as soon as the conditions allow. The abovementioned steps therefore carry on being implemented in a loop in the inhibited state, whereas they are interrupted in the deactivated state.

The execution principles therefore make it possible, by relying on data collected together and originating from various types of sources, to inhibit the SALC function when this is preferable and to reactivate it as soon as possible, which will increase the driver's level of confidence in this function.

If the SALC function is momentarily inhibited, information relating to this inhibition is transmitted to the driver, for example via the display screen or via any other interface available to the driver (step S6). The message displayed here will preferably mention the reason why no lane change is momentarily possible (“roadworks zone”, etc.).

If the SALC function remains activated and if a lane change request is received from the driver via their indicators, the computer 11 uses the previously computed control instruction and transmits it in a step S7 to the power steering actuator, which may then carry out the desired lane change maneuver, for example to pass a vehicle.

It should be noted here that this lane change may be interrupted or made faster than initially planned (that is to say the instruction may be corrected during execution) if the preliminary data relating to the environment indicate a significant change to be taken into account.

Typically, if the vehicle is driving in the right-hand lane of a three-lane road, and its driver then triggers a lane change to the second lane at the time when another vehicle is moving from the third lane to the second lane, the second data ODD2 may indicate this change and the instruction may be corrected in order to return the vehicle to the right-hand lane or in order to speed up the vehicle.

The idea here is to ensure that, when the vehicle has started changing lane and the conditions are no longer deemed suitable to carry out such a lane change, the vehicle terminates this semi-automatic lane change more quickly and the SALC function is able to be quickly deactivated or inhibited.

This will typically be the case when the vehicle arrives:
at a roadworks zone that was not detected previously,
in the proximity of an emergency vehicle on a call that was not detected previously,
on a slippery road,
in the proximity of a newly detected pedestrian or cyclist;
in the proximity of a zone with dense traffic, etc.

It may be noted at this stage that the inhibition (and de-inhibition) will be carried out automatically by the computer, thus facilitating the use of the SALC function for the driver while at the same time increasing the safety thereof.

The present invention is in no way limited to the embodiment described and shown, but rather those skilled in the art will know how to add thereto any variant according to the invention.

1-10. (canceled)

11. A method for controlling a motor vehicle, comprising, when the motor vehicle is on a road comprising at least two lanes and a semi-automatic lane change function is activated, the following steps:
acquiring first data relating to an environment of the motor vehicle;
comparing the acquired first data with a set of predetermined rules from a national and/or international regulation;
determining an activated or deactivated state of said function depending on a result of said comparing;
when said function is activated and a lane change request is received from a driver of the motor vehicle, determining a control instruction for at least one actuator for controlling the motor vehicle;
applying said control instruction via said at least one actuator so as to change the lane of the motor vehicle;
wherein the acquiring includes acquiring second data relating to the environment of the motor vehicle, the second data being distinct from said first data compared to said rules, and
wherein the acquired second data are used to determine the activated or deactivated state of said function and/or to correct said control instruction, when the function is activated and a lane change is in progress.

12. The control method as claimed in claim 11, wherein, in the determining said state, the state of said function is chosen from among the following states: activated, deactivated and momentarily inhibited.

13. The control method as claimed in claim 12, wherein the determining said state includes:
choosing either the deactivated state or one of the activated or momentarily inhibited states depending on the result of said comparing, and
when the deactivated state has not been chosen, selecting the activated state or the momentarily inhibited state depending on the acquired second data.

14. The control method as claimed in claim 12, wherein, when said function changes to the deactivated state, the acquisition and comparison steps are stopped, whereas, when said function changes to the momentarily inhibited state, the acquisition and comparison steps continue.

15. The control method as claimed in claim 11, wherein said control instruction is corrected during a maneuver depending on the acquired second data.

16. The control method as claimed in claim 11, wherein, in the acquisition step, at least some of the first and/or second data are acquired from a database of map data.

17. The control method as claimed in claim 11, wherein, in the acquisition step, at least some of the first and/or second data are acquired via communication means with which the motor vehicle is equipped.

18. The control method as claimed in claim 11, wherein, in the acquisition step, at least some of the first and/or second data are acquired via sensors with which the motor vehicle is equipped.

19. The control method as claimed in claim 11, wherein, in the acquisition step, third data relating to an operating state and/or a position and/or dynamics of the motor vehicle are acquired and, in the determination step, the state is selected depending on said third data.

20. The motor vehicle, comprising:
means for acquiring data relating to the environment of the motor vehicle;
the at least one actuator to control the motor vehicle; and
a computer programmed to implement the control method as claimed in claim 11.
